(19) United States
(12) Patent Application Publication
(10) Pub. No.: US 2024/0149479 A1
(43) Pub. Date: May 9, 2024

(54) MULTIFUNCTIONAL PET SCISSOR

(71) Applicant: YUYAO RIKE ELECTRIC APPLIANCE CO., LTD., Yuyao (CN)

(72) Inventor: ZHENBO HU, Yuyao (CN)

(21) Appl. No.: 18/093,994

(22) Filed: Jan. 6, 2023

(30) Foreign Application Priority Data
Nov. 3, 2022 (CN) 202211370418.2
Nov. 3, 2022 (CN) 202222964917.6

(51) Int. Cl. B26B 19/44; B26B 19/24; B26B 19/38

(52) U.S. Cl. CPC B26B 19/44; B26B 19/24; B26B 19/3853; B26B 19/3886

(57) ABSTRACT

The present disclosure provides a multifunctional pet scissor, including a pet scissor main body, wherein a dust collector connecting cylinder is installed at at bottom of the pet scissor main body, and the dust collector connecting cylinder may be connected to a dust collector; and an air duct communicating with the connecting cylinder is arranged inside the pet scissor main body, and when shaving the pet, the dust collector is connected so as to directly absorb the hair into the dust collector. The multifunctional pet scissor further includes a knife rest, a knife head is arranged on the knife rest; the knife rest may be detachably arranged at an outer side of the pet scissor main body, so that the knife rest may be taken down from the pet scissor main body, and then the knife head on the knife rest can be cleaned.

### CROSS-REFERENCE TO RELATED APPLICATIONS

This is a U.S. patent application which claims the priority and benefit of Chinese Patent Application Number 202222964917.6, filed on Nov. 3, 2022 and Chinese Patent Application Number 202211370418.2, filed on Nov. 3, 2022, the disclosure of which is incorporated herein by reference in its entirety.

### TECHNICAL FIELD

The present disclosure belongs to the technical field of pet scissors, in particular to a multifunctional pet scissor.

### BACKGROUND

Due to population aging, the demand for pets is greatly improved, and a pet is no longer regarded as an animal, but more as a family member. The fast pace of modern society makes people suffer greater stress, so many people relieve loneliness and relax themselves by relying on the pet. More and more people regard keeping the pet a fashion, and a typical life scene of walking with the pet has become a common sight on streets of many cities.

People's thought ideas have changed, the pet is more and more regarded as the companion of people, specifically, with higher disposable income, urban residents are willing to spend more money on the pet. The society is undergoing the unprecedented transformation, the interpersonal relationship is more complicated than ever before; and the popularization of the price of the living pet has accelerated the process of getting the pet into the family.

In the hot summer, pet shearing may cool the pet down and reduce the probability of heat stroke; the pet shearing may reduce the situation of hair removal; and a pet scissor is usually used for pet shearing.

With a single function, the existing pet scissor can only perform the pet shearing, and the falling hair increases the inconvenient cleaning.

### SUMMARY

The purpose of the present disclosure is to provide a multifunctional pet scissor, which may be connected to a dust collector, so as to absorb hair into the dust collector.

In order to implement the above purpose, the present disclosure provides a technical solution below: a multifunctional pet scissor, including a pet scissor main body, wherein a dust collector connecting cylinder is installed at at bottom of the pet scissor main body, so that the dust collector connecting cylinder is spiced with the pet scissor main body, and the dust collector connecting cylinder may be connected to a dust collector, and an air duct communicating with the connecting cylinder is arranged inside the pet scissor main body, and when shaving the pet, the dust collector is connected so as to absorb the hair into the dust collector directly, thereby collecting the hair intensively and reducing the inconvenience of cleaning the hair additionally.

Preferably, the pet scissor further includes a knife rest, a knife head is arranged on the knife rest, and the knife head is protected through the knife rest.

Preferably, the knife rest may be detachably arranged at an outer side of the pet scissor main body, so that the knife rest may be taken down from the pet scissor main body, and then the knife head on the knife rest can be cleaned; and after cleaning, the knife rest with the knife head is installed on the pet scissor main body.

Preferably, a moving knife regulating switch is arranged at an upper part of the outer side of the pet scissor main body, the length may be adjusted at will through the moving knife regulating switch, thereby creating more exquisite long, medium and short models.

Preferably, one side, located at the moving knife regulating switch, of the outer side of the pet scissor main body is provided with a power switch, to implement the increase of the power switch; and the turn-on/turn-off of the pet scissor is controlled through the power switch.

Preferably, one side, located at the power switch, of the outer side of the pet scissor main body is provided with a groove, and symmetrically distributed charging plugs are arranged inside the groove, thereby charging the pet scissor when in insufficient power.

Preferably, a plurality of grids are arranged at a lower part of the outer side of the pet scissor main body.

Preferably, an extension portion is arranged at the outer side of the dust collector connecting cylinder, thereby implementing the increase of the extension portion.

Compared with the prior art, the present disclosure has the following beneficial effects:
when shaving the pet, the hair may be directly absorbed into the dust collector by the air duct, thereby collecting the hair intensively, reducing the inconvenience of cleaning the hair additionally, and increasing the function of the pet scissor.

### BRIEF DESCRIPTION OF DRAWINGS

FIG. 1 is a schematic diagram of a solid structure of a first perspective in the present disclosure.

FIG. 2 is a schematic diagram of an enlarged structure in area E in FIG. 1 of the present disclosure.

FIG. 3 is a schematic diagram of a solid structure of a second perspective in the present disclosure.

In the drawing: 1. Pet scissor main body; 2. Power switch; 3. Grid; 4. Extension portion; 5. Dust collector connecting cylinder; 6. Moving knife regulating switch; 7. Knife head; 8. Knife head; 11. Charging plug; 12. Groove; 13. Air duct.

### DETAILED DESCRIPTION

The technical solutions in the embodiments of the present disclosure are clearly and completely elaborated below in combination with the drawings. It is apparent that the described embodiments are only a part of the embodiments of the present disclosure but not all. Based on the embodiments of the present disclosure, all the other embodiments obtained by those of ordinary skill in the art on the premise of not contributing creative effort should belong to the protection scope of the present disclosure.

### Embodiment 1

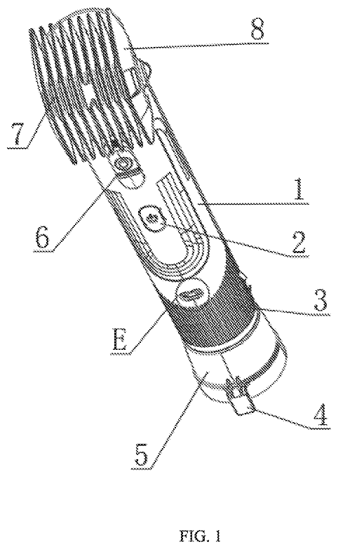

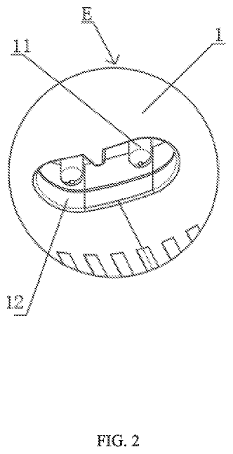

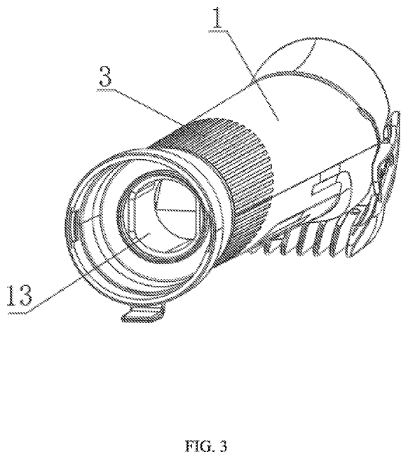

Please refer to FIG. 1 to FIG. 3, which is a first embodiment of the present disclosure. This embodiment provides a multifunctional pet scissor, including a pet scissor main body 1, wherein a dust collector connecting cylinder 5 is installed at at bottom of the pet scissor main body 1, so that the spicing between the pet scissor main body 1 and the dust collector connecting cylinder 5 is implemented, and the dust collector connecting cylinder 5 may be connected to a dust collector; and an air duct 13 communicating with the connecting cylinder 5 is arranged inside the pet scissor main body 1, and when shaving the pet, the dust collector is connected so as to absorb the hair into the dust collector directly, thereby collecting the hair intensively and reducing the inconvenience of cleaning the hair additionally

In this embodiment, preferably, the pet scissor further includes a knife rest 8, a knife head 7 is arranged on the knife rest 8, and the knife head 7 is protected through the knife rest 8.

In this embodiment, preferably, the knife rest 8 may be detachably arranged at an outer side of the pet scissor main body 1, so that the knife rest 8 may be taken down from the pet scissor main body 1, and then the knife head 7 on the knife rest 8 can be cleaned; and after cleaning, the knife rest 8 with the knife head 7 is installed on the pet scissor main body 1.

In this embodiment, preferably, a power switch 2 is arranged at an outer side of the pet scissor main body 1, to implement the increase of the power switch 2; and the turn-on/turn-off of the pet scissor is controlled through the power switch 2.

In this embodiment, preferably, one side, located at the power switch 2, of the outer side of the pet scissor main body 1 is provided with a groove 12, to implement the increase of the groove 12; and symmetrically distributed charging plugs 11 are arranged inside the groove 12, to implement the increase of the charging plugs 11, so the pet scissor may be charged when in insufficient power.

In this embodiment, preferably, a plurality of grids 3 are arranged at a lower part of the outer side of the pet scissor main body 1.

In this embodiment, preferably, an extension portion 4 is arranged at the outer side of the dust collector connecting cylinder 5.

### Embodiment 2

Please refer to FIG. 1 to FIG. 3, which is a second embodiment of the present disclosure, and based on the above embodiment, this embodiment has the following difference:

A moving knife regulating switch 6 is arranged at an upper part of the outer side of the pet scissor main body 1, the length may be adjusted at will through the moving knife regulating switch 6, thereby creating more exquisite long, medium and short models.

The working principle and the use process of the present disclosure are as follows: during use, the dust collector connecting cylinder 5 is connected to the pet scissor main body 1, the knife rest 8 with the knife head 7 is installed on the pet scissor main body 1, the turn-on/turn-off of the pet scissor is controlled through the power switch 2, and the dust collector connecting cylinder 5 is connected to the dust collector, the pet scissor main body 1 is held, and the pet is shaved through the knife head 7; and the dust collector may directly absorb the hair through the air duct 13, thereby collecting the hair intensively and reducing the inconvenience of cleaning the hair additionally.

Although the embodiments of the present disclosure have been presented and described, as shown in the above detail description; those of ordinary skill in the art may understand that various changes, modifications, replacements and deformations can be made to these embodiments without deviating from the principle of spirit of the present disclosure, and the scope of the present disclosure is defined by the appended claims and their equivalents.

What is claimed is:

1. A multifunctional pet scissor, comprising a pet scissor main body (1), wherein a dust collector connecting cylinder (5) is installed at at bottom of the pet scissor main body (1), and the dust collector connecting cylinder (5) is connected to a dust collector; and an air duct (13) communicating with the connecting cylinder (5) is arranged inside the pet scissor main body (1).

2. The multifunctional pet scissor according to claim 1, further comprising a knife rest (8), a knife head (7) is arranged on the knife rest (8).

3. The multifunctional pet scissor according to claim 2, wherein the knife rest (8) is detachably arranged at an outer side of the pet scissor main body (1).

4. The multifunctional pet scissor according to claim 1, wherein a moving knife regulating switch (6) is arranged at an upper part of the outer side of the pet scissor main body (1).

5. The multifunctional pet scissor according to claim 4, wherein one side, located at the moving knife regulating switch (6), of the outer side of the pet scissor main body (1) is provided with a power switch (2).

6. The multifunctional pet scissor according to claim 5, wherein one side, located at the power switch (2), of the outer side of the pet scissor main body (1) is provided with a groove (12), and symmetrically distributed charging plugs (11) are arranged inside the groove (12).

7. The multifunctional pet scissor according to claim 1, wherein a plurality of grids (3) are arranged at a lower part of the outer side of the pet scissor main body (1).

8. The multifunctional pet scissor according to claim 1, wherein an extension portion (4) is arranged at the outer side of the dust collector connecting cylinder (5).
